(19) United States
(12) Patent Application Publication
(10) Pub. No.: US 2004/0042582 A1
(43) Pub. Date: Mar. 4, 2004

(54) Method and apparatus for locating a medical target

(76) Inventor: Moshe Ein-Gal, Ramat Hasharon (IL)

Correspondence Address: Dekel Patent Ltd., Beit HaRofim, Room 27, 18 Menuha VeNahala Street, Rehovot, IL

(21) Appl. No.: 10/232,512

(22) Filed: Sep. 3, 2002

(51) Int. Cl. G21K 1/12

(52) U.S. Cl. 378/8

(57) ABSTRACT

Apparatus for locating a target, comprising an irradiation device comprising a radiation source adapted to emit a radiation beam along a beam axis, and an imaging probe mounted on the irradiation device along the beam axis. A method is also provided for locating a target, which may further comprise obtaining a first image of a target area of a body to be irradiated in a first spatial plane, positioning the target area of the body to lie within an isocenter of the irradiation device, forming a second image of the target area with the imaging probe corresponding to the first spatial plane, and comparing the first and second images corresponding to the first spatial plane, wherein if the first and second images corresponding to the first spatial plane do not match within a tolerance, moving the body and again forming a second image of the target area with the imaging probe corresponding to the first spatial plane until the first and second images corresponding to the first spatial plane match within a tolerance.

### FIELD OF THE INVENTION

The present invention relates generally to methods and apparatus for accurately determining the location of a target in a medical procedure, such as for carrying out precision radiation therapy treatment or surgery of an organ in a body.

### BACKGROUND OF THE INVENTION

The accurate placement and positioning of patients is crucial when performing many types of medical treatments. One category of medical treatments in which the proper placement and verification of the position of an organ is of particular importance is in the field of radiation therapy.

Radiation therapy involves medical procedures that selectively expose certain areas of a body, such as cancerous tumors, to high doses of radiation. The intent of the radiation therapy is to irradiate the targeted biological tissue such that the harmful tissue is destroyed. To minimize damage to surrounding body tissues, the radiation dosage is generally delivered in a planned series of treatment sessions that each delivers only a portion of the total planned dosage. Healthy body tissues typically have greater capacity to recover from the damage caused by exposed radiation. Spreading the delivered radiation over many treatment sessions allows the healthy tissue an opportunity to recover from radiation damage, thus reducing the amount of permanent damage to healthy tissues while maintaining enough radiation exposure to destroy tumoral tissue.

The efficacy of the radiation treatment depends in large part upon the ability to irradiate the exact same position on the body at the various radiation sessions. The goal is to place the patient in the same position relative to the radiation source at each and every treatment session. Inaccuracies in positioning the patient may result in errors in radiation dosage and/or treatment locations, leading to unpredictable disease relapse or damage to healthy tissues. In conventional medical treatment systems, the accurate placement and verification of a repeating treatment location on the human body remains a significant problem in implementing dose fractionating treatment plans.

There are several methods that attempt to achieve an accurate and repeatable treatment location on the human body. One method places marks or tattoos, or attaches radio-opaque balls, at specific locations on the patient's skin. Several laser or light sources from predetermined locations project beams of light at the patient's body. To control the patient positioning, a therapist shifts the position of the patient until the marks are aligned with the lines of light from the lasers or light sources. For example, a camera may cooperate with a LINAC (linear accelerator) and a computer to enable treatment of a patient with a beam that is positioned and maintained on a specific target in a patient's body. The camera may be located in a known position with respect to the LINAC and the markers at specific locations on a patient's body. Anatomical targets may be identified and positioned with respect to the treatment beam from the LINAC as identified by the camera data.

Another method employs an immobilization device to maneuver the patient into a particular position. A stereotactic head frame used in radiotherapy or radiosurgery procedures is an example of such a device. The immobilization device physically attaches to the human body to keep the patient from moving once proper positioning is achieved.

However, these and other known methods suffer from serious drawbacks. These methods are ineffective for certain internal organs that may move relative to stationary outer parts of the patient's body. For example, accurate determination of the position of the prostate in radiotherapy is problematic. The prostate may move with respect to previously recorded markers. Another complication is that the prostate is located very close to radiation sensitive tissues, such as the bladder and rectum.

In general, in the prior art, radiotherapy of the prostate may comprise a computerized tomography (CT) scan, or any other imaging technique, such as but not limited to, magnetic resonance imaging (MRI), of the pelvis to determine the approximate size, shape and location of the prostate gland (the intended target of the radiation). The patient may then undergo a treatment simulation in which planar, diagnostic X-ray films are taken in the plane of each of the proposed radiation fields. These X-ray films define the spatial position of the prostate (or target volume) and radiation sensitive structures, such as the rectum and bladder. The shape and position of the prostate, however, may change with time and may be different from when the CT images were taken. Consequently a margin of dimensional safety is generally drawn around the prostate volume to account for the variation of patient setup, target motion, and the spatial approximations inherent in localizing the prostate from the CT images to the simulator images. This margin is intended to insure that the prostate gland is receiving the intended dose. However, because of the uncertainties, the radiation doses to the prostate may not be optimal at all, and portions of the nearby rectum and bladder may also receive high doses.

### SUMMARY OF THE INVENTION

The present invention seeks to provide methods and apparatus for locating a medical target. In the present invention, an imaging probe may be mounted directly on an irradiation device, wherein the imaging axis of the probe is aligned with the beam axis of the irradiation device. Images produced by the imaging probe may be conveniently compared with previously obtained images of the target area, and the patient may be moved with respect to the beam axis in accordance with the results of the comparison. Once the images match, the patient is now correctly aligned with the beam axis of the irradiation device, since the imaging probe has already been aligned with the beam axis. The invention may thus provide accurate location and alignment of the target, without having to take into account or correct for the gantry arm position, for example.

There is thus provided in accordance with an embodiment of the invention apparatus for locating a target, comprising an irradiation device comprising a radiation source adapted to emit a radiation beam along a beam axis, and an imaging probe mounted on the irradiation device along the beam axis. The imaging probe may have an imaging axis collinear with the beam axis.

In accordance with an embodiment of the invention the imaging probe is rotatably mounted on the irradiation device along the beam axis.

Further in accordance with an embodiment of the invention the imaging probe is mounted on a rotating base attached to the irradiation device, the rotating base comprising a stopping device for arresting the imaging probe at two or more predetermined angular positions. The rotating base may be adjustable such that the imaging axis is alignable with the beam axis. The imaging probe may comprise a computerized tomography (CT) probe, a magnetic resonance imaging (MRI) probe, an ultrasound imaging probe, a positron emission tomography (PET) probe or a single photon emission computed tomography (SPECT) probe.

There is also provided in accordance with an embodiment of the invention apparatus for locating a target, comprising an imaging probe mounted on a rotating base attachable to an irradiation device along a beam axis thereof.

There is also provided in accordance with an embodiment of the invention a method for locating a target comprising providing an irradiation device comprising a radiation source adapted to emit a radiation beam along a beam axis, and mounting an imaging probe on the irradiation device along the beam axis.

In accordance with an embodiment of the invention, the method further comprises obtaining a first image of a target area of a body to be irradiated in a first spatial plane, positioning the target area of the body to lie within an isocenter of the irradiation device, forming a second image of the target area with the imaging probe corresponding to the first spatial plane, and comparing the first and second images corresponding to the first spatial plane, wherein if the first and second images corresponding to the first spatial plane do not match within a tolerance, moving the body and again forming a second image of the target area with the imaging probe corresponding to the first spatial plane until the first and second images corresponding to the first spatial plane match within a tolerance.

The method may further comprising obtaining another first image of the target area in a second spatial plane, the first and second spatial planes being rotated with respect to one another, rotating the image probe about the beam axis (e.g., by at least 90°) to a position corresponding to the second spatial plane, forming a second image of the target area with the imaging probe corresponding to the second spatial plane, and comparing the first and second images corresponding to the second spatial plane, wherein if the first and second images corresponding to the second spatial plane do not match within a tolerance, moving the body and again forming a second image of the target area with the imaging probe corresponding to the second spatial plane until the first and second images corresponding to the second spatial plane match within a tolerance.

The first and second images of the target area may be obtained with CT, MRI, ultrasound imaging, PET and/or SPECT.

In accordance with an embodiment of the invention the first image of the target area is registered with respect to a reference marker.

Further in accordance with an embodiment of the invention the reference marker may comprise seeds introduced to the target area, the seeds being opaque to the first and second images and being internal to an organ in which lies the target area.

The imaging probe may contact the body in the vicinity of the target area and may be moved along the beam axis.

### BRIEF DESCRIPTION OF THE DRAWINGS

The present invention will be understood and appreciated more fully from the following detailed description taken in conjunction with the drawings in which:

FIG. 1 is a simplified side-view illustration of apparatus for locating a target, constructed and operative in accordance with an embodiment of the invention, comprising an imaging probe attached to a gantry arm;

FIG. 2 is a simplified side-view illustration of the apparatus of FIG. 1 showing the imaging probe being brought into contact with a patient, in accordance with an embodiment of the invention;

FIG. 3 is a simplified illustration of alignment of an image obtained from the imaging probe with an image previously obtained by other imaging equipment;

FIG. 4 is a simplified side-view illustration of the apparatus of FIG. 1 showing a patient table being adjusted to align the imaging probe with a target in the patient, in accordance with an embodiment of the invention; and

FIG. 5 is a simplified illustration of the image obtained from the imaging probe aligned with the image previously obtained by other imaging equipment, as a result of the adjustment made in FIG. 4.

### DETAILED DESCRIPTION OF A PREFERRED EMBODIMENT

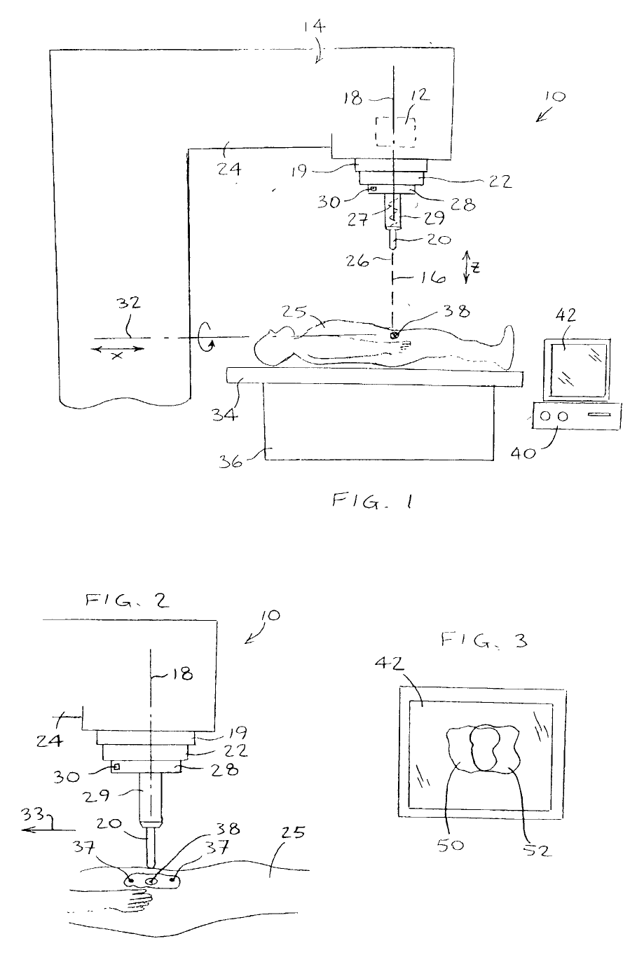

Reference is now made to FIG. 1, which illustrates apparatus 10 for locating a target, constructed and operative in accordance with an embodiment of the invention.

Apparatus 10 may include a radiation source 12 housed in an irradiation device 14, such as but not limited to, a linear accelerator (LINAC). The radiation source 12 may emit a radiation beam 16 along a beam axis 18. An imaging probe 20 may be mounted on irradiation device 14 along beam axis 18. Imaging probe 20 may comprise any type of probe used in imaging systems, such as but not limited to, a computerized tomography (CT) probe, a magnetic resonance imaging (MRI) probe, an ultrasound imaging probe, a positron emission tomography (PET) probe or a single photon emission computed tomography (SPECT) probe. A beam collimator 19 may collimate radiation beam 16.

Imaging probe 20 may be rotatably mounted on a turret 22 of a gantry arm 24 of irradiation device 14. Imaging probe 20 may be arranged so that its imaging axis 26 is collinear with the beam axis 18. In one embodiment of the invention, imaging probe 20 may be mounted on a rotating base 28 attached to turret 22. A holder 29 may be used to attach imaging probe 20 to rotating base 28, wherein holder 29 may comprise a spring arm or other biasing device 27 to enable applying constant pressure on a patient 25 with imaging probe 20. Rotating base 28 may comprise a stopping device 30, such as but not limited to, detents or pawls, for example, for arresting imaging probe 20 at two or more predetermined angular positions. For example, stopping device 30 may arrest imaging probe 20 at 0° and 90° with respect to a rotational axis 32 of gantry arm 24. Axis 32 preferably coincides with a longitudinal axis of a patient table 34. The imaging planes corresponding to the angular positions 0° and 90° with respect to rotational axis 32 correspond respectively to axial and sagittal images of patient 25 lying on table 34. Rotating base 28 may be adjustable such that the imaging axis 26 is alignable with the beam axis 18. The x-y-z position of table 34 may be adjusted and moved by means of a positioner 36. The x-axis movement, for example, refers to movement along axis 32; the y-axis movement refers to movement along an axis perpendicular to axis 32 (in and out of the page of FIG. 1); and the z-axis movement refers to movement along axis 18 (or 26).

Beam axis 18 preferably intersects gantry rotational axis 32 at an isocenter 38. Imaging probe 20 is preferably aligned on beam axis 18 above the isocenter 38 and pointing thereat. The isocenter 38 should be in the target area of radiation of the patient 25.

An imaging processing unit 40 may be provided in communication with imaging probe 20, for processing images and displaying them on a display 42.

Reference is now made to FIGS. 2-5, which illustrate a method for locating a target using apparatus 10, in accordance with an embodiment of the invention. The invention seeks to find a match between prior images, such as but not limited to, CT sections, and current images obtained with imaging probe 20.

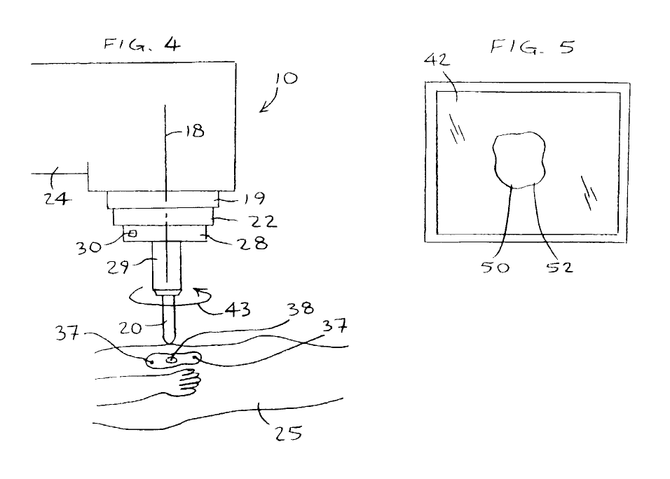

Before commencing the procedure, registered and contoured images of the target area in a particular spatial plane may be imported to imaging processing unit 40, such as but not limited to, axial and sagittal sections of the target area. These images may have been obtained previously with imaging equipment not necessarily connected with imaging probe 20, such as with some CT, MRI, PET, SPECT or ultrasound system (not shown). An image 50 (e.g., axial image section) containing the contoured target area that corresponds to the isocenter may be displayed on display 42, as shown in FIG. 3. This image of the target area may be registered with respect to a reference marker 37, such as some mark in or on the patient 25.

In accordance with an embodiment of the invention, reference marker 37 comprises metallic or non-metallic seeds introduced to the target area (e.g., the prostate), such as by insertion with a needle-like instrument. The seeds are preferably opaque to the particular kind of imaging system being used, such as ultrasonic or CT, for example. Reference markers 37 are internal to the organ of interest, and therefore may not significantly move with respect to the target area, thereby serving their purpose as a position reference.

As seen in FIG. 2, the patient 25 may be positioned so that the target area is supposedly or approximately in the isocenter 38. This may be accomplished by means of body tattoos, room lasers and/or LINAC ruler, for example. Imaging probe 20 may be adjusted or moved so that its imaging axis 26 is substantially collinear with the beam axis 18 of the radiation source 12.

In FIG. 2, the patient 25 may be raised (e.g., by moving the table 34) so that imaging probe 20 presses against patient 25 in the vicinity of the target area. Alternatively, imaging probe 20 may be moved until it presses against patient 25. An image 52 of the target area may be produced with imaging probe 20, corresponding to the spatial plane of the previously obtained image, e.g., the axial plane. The image 52 as obtained by imaging probe 20 may then be compared with the previously obtained image 50 corresponding to the particular spatial plane. If the images 50 and 52 do not match within a tolerance, as seen in FIG. 3, the patient's body may be moved in the horizontal plane (e.g., in the x axis, as indicated by arrow 33) to reduce the offset between the two images. Table 34 may be moved in increments, e.g., of about 1 mm, with imaging probe 10 pressing upon the patient 25. The force of imaging probe is preferably small (e.g., about 2 kg), and does not interfere with the motion of table 34. Table 34 may be moved manually or automatically with feedback control.

Afterwards, as shown in FIG. 4, imaging probe 20 may be used to form another image 52 of the target area corresponding to the particular spatial plane, the images 50 and 52 may be compared and the patient 25 accordingly moved again, until the two images 50 and 52 match within a tolerance.

Once a match has been obtained, as shown in FIG. 5, rotating base 28 may be rotated about beam axis 18 by 90°, as indicated by an arrow 43 in FIG. 4 (e.g., by means of an easy click mechanism or similar mechanism), and another set of images may be taken of the next spatial plane. These images may be compared with the corresponding previously obtained images of that particular spatial plane (e.g., the sagittal plane), and the patient moved, if necessary, as described before.

Once a match has been obtained in both spatial planes, then the patient 25 may be considered properly aligned. If necessary, patient 25 may then be moved generally along beam axis 18 (e.g., by lowering or raising table 34) to the proper z-position.

It will be appreciated by person skilled in the art, that the present invention is not limited by what has been particularly shown and described herein above. Rather the scope of the present invention is defined only by the claims that follow:

What is claimed is:

1. Apparatus for locating a target, comprising:
an irradiation device comprising a radiation source adapted to emit a radiation beam along a beam axis; and
an imaging probe mounted on said irradiation device along the beam axis.

2. The apparatus according to claim 1, wherein said imaging probe has an imaging axis collinear with the beam axis.

3. The apparatus according to claim 1, wherein said imaging probe is rotatably mounted on said irradiation device along the beam axis.

4. The apparatus according to claim 3, wherein said imaging probe is mounted on a rotating base attached to said irradiation device, said rotating base comprising a stopping device for arresting said imaging probe at at least two predetermined angular positions.

5. The apparatus according to claim 1, wherein said imaging probe comprises at least one of a computerized tomography (CT) probe, a magnetic resonance imaging (MRI) probe, an ultrasound imaging probe, a positron emission tomography (PET) probe and a single photon emission computed tomography (SPECT) probe.

6. Apparatus for locating a target, comprising:
an imaging probe mounted on a rotating base attachable to an irradiation device along a beam axis thereof.

7. The apparatus according to claim 6, wherein said imaging probe has an imaging axis and said rotating base is adjustable such that the imaging axis is alignable with the beam axis.

8. The apparatus according to claim 6, wherein said rotating base comprises a stopping device for arresting said imaging probe at at least two predetermined angular positions.

9. A method for locating a target comprising:
providing an irradiation device comprising a radiation source adapted to emit a radiation beam along a beam axis; and
mounting an imaging probe on said irradiation device along the beam axis.

10. The method according to claim 9, further comprising aligning an imaging axis of said imaging probe to be collinear with the beam axis.

11. The method according to claim 9, further comprising:
obtaining a first image of a target area of a body to be irradiated in a first spatial plane;
positioning the target area of the body to lie within an isocenter of said irradiation device;
forming a second image of said target area with said imaging probe corresponding to said first spatial plane; and
comparing said first and second images corresponding to said first spatial plane, wherein if said first and second images corresponding to said first spatial plane do not match within a tolerance, moving said body and again forming a second image of said target area with said imaging probe corresponding to said first spatial plane until said first and second images corresponding to said first spatial plane match within a tolerance.

12. The method according to claim 11, further comprising:
obtaining another first image of the target area in a second spatial plane, said first and second spatial planes being rotated with respect to one another;
rotating said image probe about said beam axis to a position corresponding to said second spatial plane;
forming a second image of said target area with said imaging probe corresponding to said second spatial plane; and
comparing said first and second images corresponding to said second spatial plane, wherein if said first and second images corresponding to said second spatial plane do not match within a tolerance, moving said body and again forming a second image of said target area with said imaging probe corresponding to said second spatial plane until said first and second images corresponding to said second spatial plane match within a tolerance.

13. The method according to claim 11, wherein obtaining said first image of the target area comprises obtaining said first image with at least one of CT, MRI, ultrasound imaging, PET and SPECT.

14. The method according to claim 11, wherein obtaining said second image of the target area comprises obtaining said second image with at least one of CT, MRI, ultrasound imaging, PET and SPECT.

15. The method according to claim 11, further comprising registering said first image of the target area with respect to a reference marker.

16. The method according to claim 15, further comprising introducing seeds to said target area to serve as said reference marker, said seeds being opaque to said first and second images and being internal to an organ in which lies said target area.

17. The method according to claim 11, further comprising causing said imaging probe to contact the body in the vicinity of said target area.

18. The method according to claim 12, wherein rotating said image probe about said beam axis comprises rotating said image probe by at least 90°.

19. The method according to claim 11, further comprising moving the body generally along said beam axis.

20. The method according to claim 12, further comprising moving the body generally along said beam axis.
